(19) United States
(12) Patent Application Publication
(10) Pub. No.: US 2008/0122361 A1
(43) Pub. Date: May 29, 2008

(54) Faceted ceramic hid lamp

(76) Inventors: Walter P. Lapatovich, Boxford, MA (US); George C. Wei, Weston, MA (US)

Correspondence Address: OSRAM SYLVANIA Inc., 100 Endicott street, Danvers, MA, 01923, US

(21) Appl. No.: 11/511,832

(22) Filed: Aug. 29, 2006

(51) Int. Cl. H01J 61/30

(52) U.S. Cl. 313/634

(57) ABSTRACT

A high intensity discharge lamp includes a ceramic envelope that defines an enclosed volume that is filled with a pressurized gas, the envelope having an exterior with axial poles and an equator and, when viewed in longitudinal cross section, plural exterior steps extending in series from the respective axial pole to the equator, each of the steps having a flat surface that is angled to refract light from inside the envelope toward a plane of the equator. The flat surfaces may be planar (plural facets in concentric tiers) or annular and the envelope may have a spherical interior surface. The lamp may have a reflector with an aperture that is aligned with the respective axial pole.

### TECHNICAL FIELD

The invention relates to electric lamps and particularly to a high intensity discharge (HID) lamp. More particularly the invention is concerned with a high intensity discharge lamp with a ceramic body used in a projection system.

### BACKGROUND ART

High pressure mercury lamps with short arc gaps and high luminance are presently used in video projection equipment (see for example “UHP lamp systems for projection applications,” G. Derra, H. Moench, E. Fischer, H. Giese, U. Hechtfischer, G. Heusler, A. Koerber, U. Niemann, F. Noertemann, P. Pekarski, J. Pollmann-Retsch, A. Ritz and U. Weichmann 2005 J. Phys. D: Appl. Phys. 38 2995-3010, and “Characteristics of sealed parts under internal pressure in super high pressure mercury discharge lamps,” M. Kase, T. Sawa, and Y. Iwama, Proceeding of American Ceramic Society Conference on Mechanical Properties and Performance of Engineering Ceramics and composites at Cocoa Beach, Fla., January 2005, ed. E. Lara-Curzio). These lamps are often referred to as UHP or PVIP lamps. The lamp envelope is made from thick (approximately 2 mm) vitreous silica. Vitreous silica is preferred because it is easily formed, is transparent and retains its strength at elevated temperatures. In operation, the temperature of the vitreous silica envelope is approximately 900° C with an internal pressure of approximately 20 MPa at this temperature. The internal pressure is the result of the high mercury dose which is vaporized during operation.

While conventional ceramic envelopes made from polycrystalline alumina (PCA) could be constructed along lines similar to the UHP or PVIP lamp, the scattering nature of the PCA makes achieving high luminance difficult. The luminance of a typical metal halide arc viewed through a vitreous silica envelope is an order of magnitude higher than through a PCA envelope. This is due to the low in-line transmittance of the PCA material.

Ceramic envelopes could also be desirable in this application because the lamp envelope runs hot and hot vitreous silica is prone to devitrification at elevated temperatures. Devitrification causes frosting of the silica envelope and loss of luminance which, over time, makes the silica envelope scattering more like that of the PCA.

There is a need for a transparent ceramic envelope that can endure the operating temperature and internal pressure and that is immune to devitrification. Consequently, the lamp luminance could be preserved over time.

Further, there is a need for a lamp with intrinsic optical features to control the direction of emitted light. A point source radiates into 4π steradians. A short arc lamp radiates more like a dipolar radiator with radiation near the poles attenuated because of shadowing by the electrodes and the press seal areas. When coupled to an optic, such as a reflector, much of the generated light is lost or at least cannot be controlled since the opening in the reflector must permit the light to pass.

Attempts have been made to recapture some of this forward radiation by applying multi-layer dielectric coatings to the lamp body itself, (A. Ritz and H. Moench, LS10: IOP Conference Series No. 182, Paper P-058, p. 301-2, July 2004). Coatings tend to crack and craze due to repeated cycling and rapid warm-up and cool down of the lamp. It is difficult to match the thermal expansion properties exactly. While the coating may largely adhere over the useful lamp life, the cracks scatter light similar to devitrification. Coatings on silica over time suffer from the dual curse of crazing and devitrification. This becomes an especially important issue as the lamp operating temperature is raised by the ever increasing need for higher pressure and higher power lamps.

### DISCLOSURE OF THE INVENTION

The present invention seeks to avoid the problems of the prior art by providing a high intensity discharge lamp that includes an envelope made of a ceramic material not prone to devitrification and that defines an enclosed volume filled with a pressurized gas, the envelope having an exterior with axial poles and an equator and, when viewed in longitudinal cross section, plural steps extending in series from the respective axial pole to the equator, each of the steps having a flat surface that is angled to refract light from inside the envelope toward a plane of the equator. The flat surfaces may be planar (facets in concentric tiers) or annular and the envelope may have a spherical interior surface. The lamp may further include a reflector that has an aperture aligned with the respective axial pole.

### BRIEF DESCRIPTION OF THE DRAWINGS

FIG. 1 is perspective view of a first embodiment of a lamp of the present invention showing the annular flat surfaces.

FIG. 2 is perspective view of a second embodiment of a lamp of the present invention showing the faceted flat surfaces.

FIGS. 3a and 3b are cross sectional views of a conventional lamp envelope showing the unrefracted light and of an embodiment of the present invention showing the refraction of emitted light toward the equator.

FIG. 4 is a schematic cross section showing an embodiment of the present invention in a reflector that directs light axially.

FIG. 5 is a partial cross sectional view illustrating refraction of light in the present invention.

FIG. 6 is a cross sectional view of an embodiment of the present invention that is electrodeless.

### BEST MODE FOR CARRYING OUT THE INVENTION

The present invention finds application in high intensity lamps for projection applications. Specifically, the invention finds application in high-pressure mercury lamps where the high pressure is generated by the mercury dose volatized during operation, and where the lamp envelope is not vitreous silica. Such lamps include a transparent or translucent lamp envelope that is filled with a suitable pressurized gas during operation. The lamp may have electrodes or be electrodeless, as is known in the art.

The envelope of the lamp of the present invention may be made from a suitable ceramic material that may be sintered into a state similar to PCA, namely polycrystalline and translucent. The ceramic material of the envelope becomes transparent when polished.

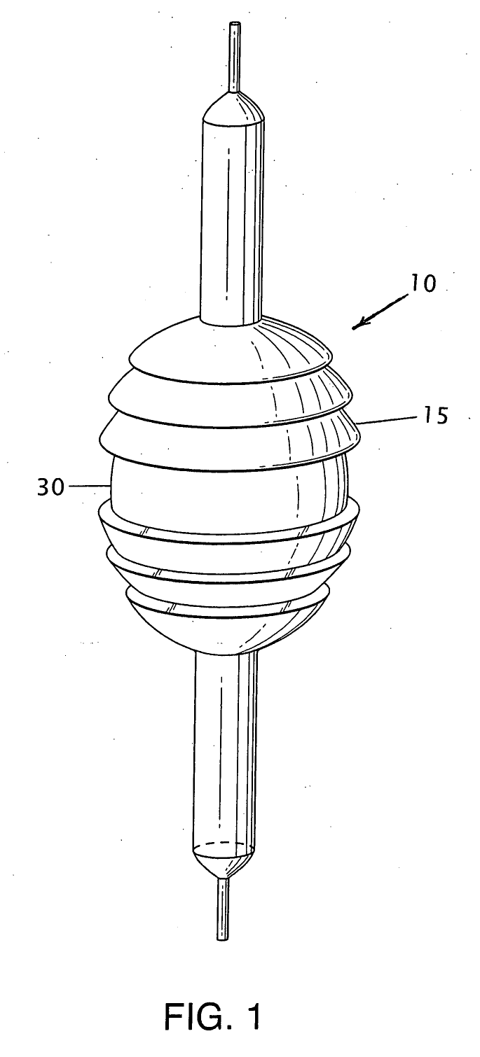

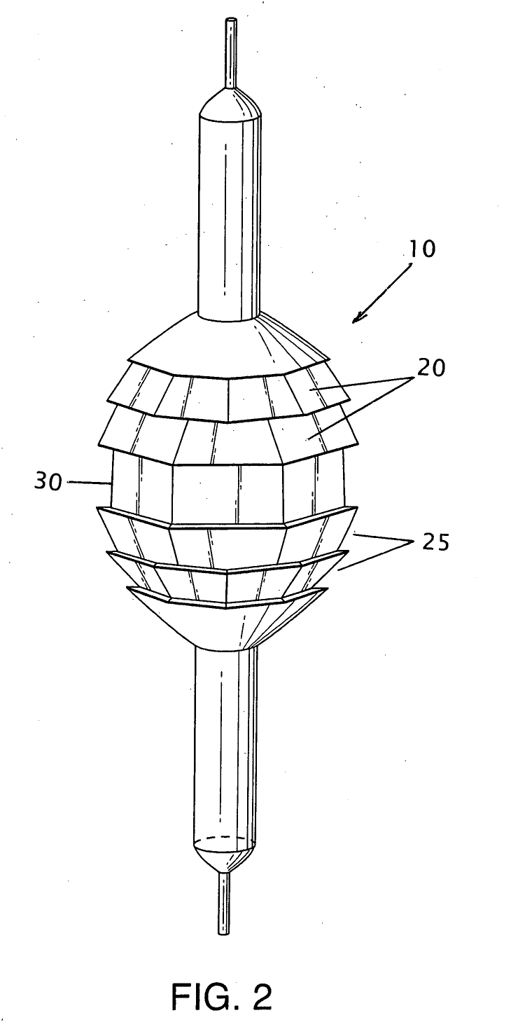

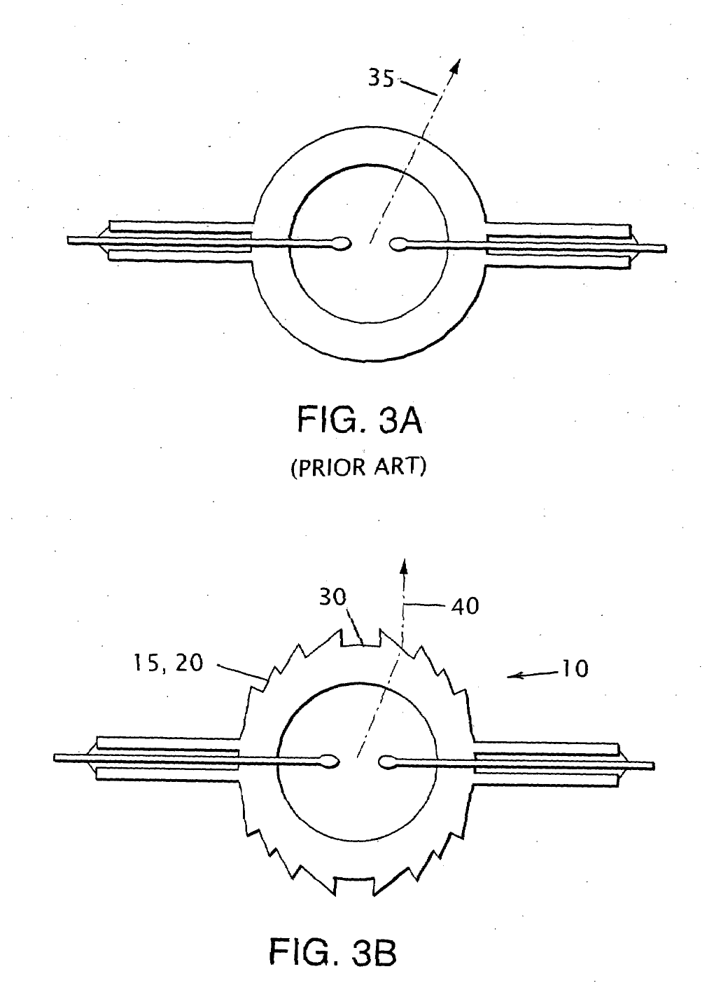

Since the envelope is to be polished to become transparent, the polishing step affords the opportunity to change the shape of the envelope to recapture some of the lost forward radiation. With reference to FIGS. 1 and 2, an exterior surface of envelope 10 may be polished to form a series of annular steps 15, such as shown in FIG. 1, or to form a plurality of separate facets 20 arrayed in tiers 25, such as shown in FIG. 2. Envelope 10 has an equator 30 and, when viewed in longitudinal cross section, each of the steps or facets has a flat surface that is angled to refract light from inside the envelope toward a plane of the equator compared to a conventional round shape, as shown in FIGS. 3A and 3B. An unrefracted ray 35 of the prior art is shown in FIG. 3A and the refracted ray 40 of the present invention is shown in FIG. 3B. The steps form a saw tooth pattern superimposed on a nominal spherical outside envelope shape. The flat surfaces 15, 20 act as prisms to redirect the dipolar radiant flux into a highly equatorially enhanced radiation pattern, akin to a flattened dipole. The number and size of these prismatic flat surfaces may be adjusted according to the reflective optic used. Thus, the polishing serves a dual purpose: achieving transparency and enhancing the optical performance of the device.

The highly peaked output provided by this envelope is favorable for coupling with a simple reflector and improves the forward gain of the lamp optic. This translates, for example, into more screen lumens for the same wattage lamp. That is, the invention permits better coupling to the control surfaces (reflector) and better system luminous flux throughput.

Projection systems, in particular video and data projection systems, use a short arc gap high intensity arc lamp. The fill in the lamp may include mercury, argon and a small amount of bromine. The bromine is added as a trace to the argon to establish a halogen cycle and clean sputtered tungsten from the walls of the arc tube. This stabilizes the lumen maintenance. Typical fill doses may be: mercury in the range of 100-300 mg/cm³, with the preferred amount of 200 mg/cm³; argon in the range of 3 to 4,000 kPa at room temperature (20° C.), with the preferred amount of 40 kPa; and bromine as a trace in the argon, in the range of 2 to 20 μg/cm³, with the preferred dose of about 11 μg/cm³. Typical lamp volumes are on the order of 50 mm³ (0.05 cm³).

The lamp may be formed initially as a tubular injection molded ceramic with rotational symmetry about the long axis of the lamp. The envelope may define an enclosed volume with a generally spherical shape. The injection-molded ceramic envelope may be aluminum oxynitride or dysprosium oxide or other cubic ceramic material such as yttrium aluminate garnet (YAG), yttria, and magnesium aluminate spinel, or submicron-grained hexagonal alumina (where submicron grain size minimizes scattering to give relatively high in-line transmittance). The cubic ceramic material may be doped with transition metal ions (Ti⁺³, Cr⁺³, Fe⁺³, etc.), rare earth ions such as Eu⁺³, Ce⁺³, and Tb⁺³ to convert UV to visible, further enhancing the light output. AlON doped with Ti⁺³ ions was discussed in D. Perera, “Phase relationships in the Ti—Al—O—N system, J. Br. Ceram. Trans., 89 (1990), p. 57. Cubic MgAlON ceramic can also be used. The mold can be made so that the rough shapes of the required ridges and zones at the outer surface are formed in the green state. This may be followed by computerized machining in the green state, sintering, consolidation, and a final polishing. The spherical body may be polished inside to achieve transparency and so that the inner shape is approximately spherical. Other forming methods, such as slip casting and gel casting with a removable core, could also be used.

As explained above, the exterior surface is polished in steps to produce ridges or zone areas which behave like prismatic elements with cylindrical symmetry bending light from the arc into a tighter beam in the equatorial plane. In cross section, the facets can form a staircase or saw tooth wrapped on the envelope exterior. The riser of each step may be on a radial line from the envelope center. The outer surface can be precision machined and mechanically polished (or chemical polishing using acids and glaze, or a combination of both) to the size and tolerance required. In the preferred embodiment of FIG. 1, the envelope may be rotated in a lathe while an abrasive wheel or contoured tool is pressed against the surface to remove material and leave the desired shape. In the embodiment of FIG. 2, the envelope may be held fixed during separate polishings and indexed through a particular angle (such as 600 to form six facets per tier) while a grinding wheel or contoured tool is pressed against the body to produce the desired facet. The angle can be changed to produce more or fewer facets per tier (e.g., 30° would produce 12 facets per tier).

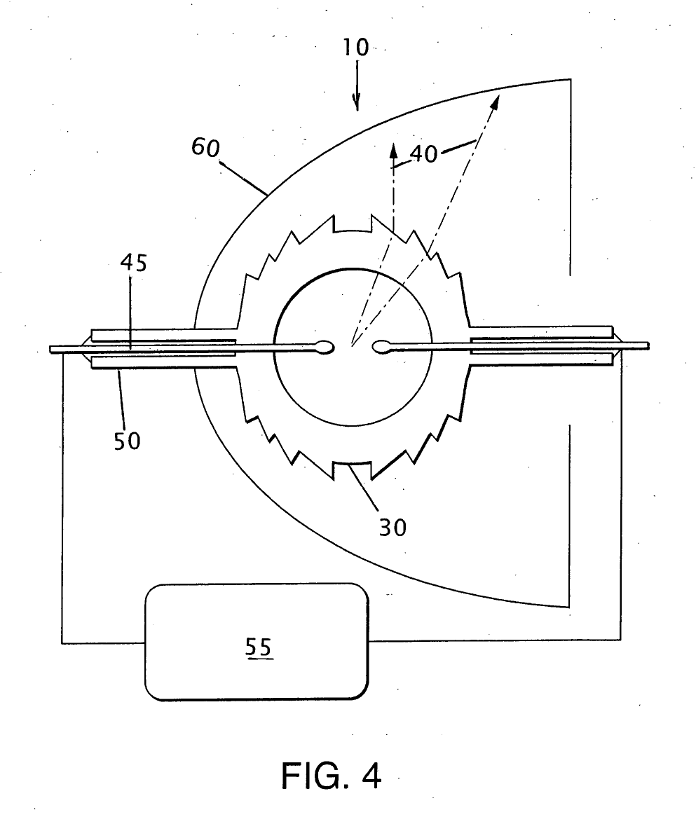

With reference now to FIG. 4, in an embodiment of the lamp with electrodes, the electrodes 45 may be of conventional design and with tungsten tips sealed into capillaries 50 using techniques known in the art. These may include, but are not limited to, low temperature glass frit sealing, such as is used in general lighting polycrystalline alumina metal halide lamps. The capillaries 50 may extend axially from the spherically shaped enclosed volume at the poles along the long axis of the lamp. A means of providing electric power to the lamp and exciting the gas sealed within into the plasma state is provided. This may include a power conditioning module, electronic ballast, or magnetic ballast 55, wiring and associated connectors. The preferred electrodes 45 are disposed so as to produce a short arc gap (1-2 mm) near the center of the interior approximately spherical surface. Upon energizing, the electric current flowing through the gap vaporizes the mercury so that the operating pressure of the lamp is approximately 15 to 20 MPa. Thus, a high luminance arc is achieved.

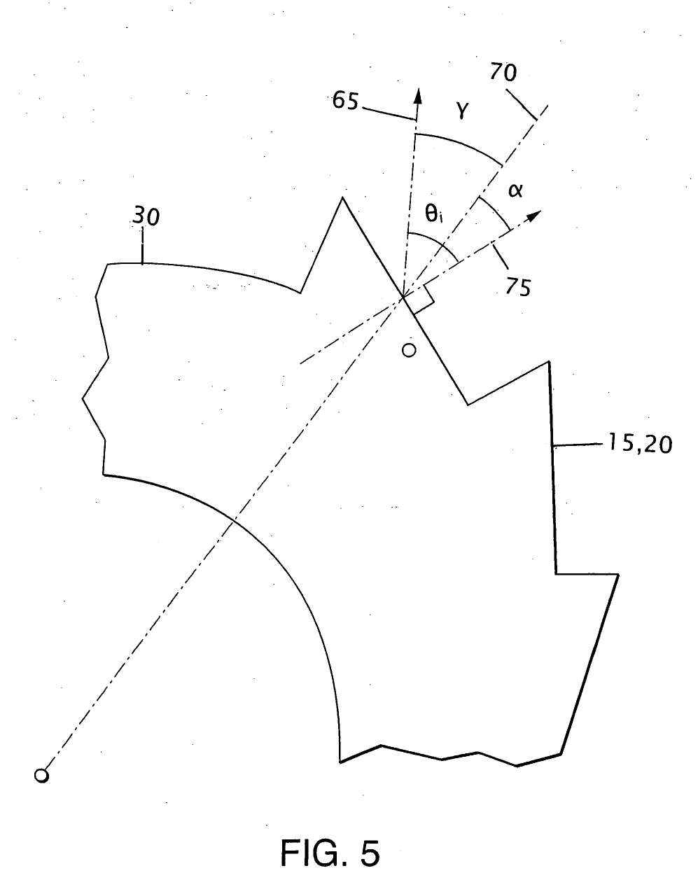

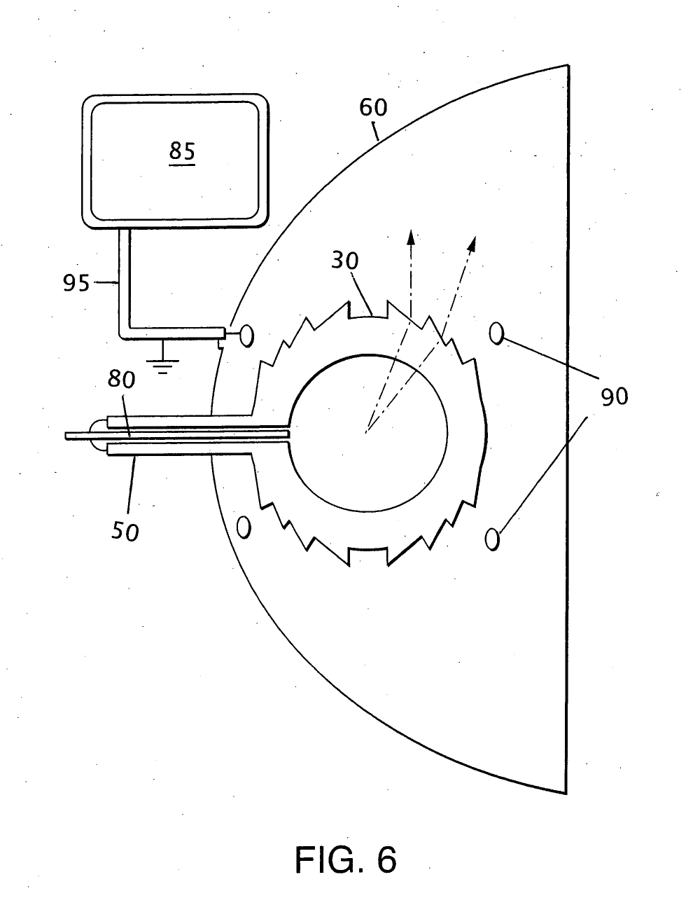

The light from the concentrated arc (luminance about 1800 Cd/mm2) passes through the sculpted ceramic arc tube and is refracted as shown in FIG. 5. This concentrates the light in the equatorial plane. The light from the envelope may be gathered by a reflector 60 (FIGS. 4 and 6) and focused as needed for the particular application. The data in Table 1 and FIG. 5 show the principle of refracting the light at the surface of the burner into a more equatorial and less polar distribution. Line 65 represents a refracted ray, line 70 represents an imaginary unrefracted ray, and line 75 represents a local surface normal.

An application of Snell's law of refraction, and the basic geometry of the instant invention in FIG. 5, gives the following relation for the angular gain into the equatorial radiation lobes:

n_{AlON}·sinΘᵢ=nₐᵢᵣ·sin Θᵣ (Snell's law)

Recall that rays traveling from optically dense media (AlON) into rarified media (air) are bent away from the local surface normal vector. Replacing the angle of incidence, θᵢ, with the facet angle, a, and using n_{AlON}|₅₃₂ nm≡1.77, the following relation is obtained:

γ=sin⁻¹{1.77·sin α}−α

Here, γ is the angular gain or the angle greater than zero through which the undeviated ray in the prior art would be deflected towards the equatorial plane. More rays into the equatorial plane increase the apparent radiance in that direction. This does not violate energy conservation because the energy is simply redirected from the polar direction. It can be seen from Table 1, that modest facet angles result in significant angular gain. Facet angles beyond about 34° result in total internal reflection at the facet interface. Each of the surfaces 15, 20 may be angled so as to avoid substantially total internal reflection of the light from a center of the envelope.

TABLE 1
Angles corresponding to geometry and rays in FIG. 5. All entries are in
degrees.

| α | Θᵣ | γ |
|---|---|---|
| 10 | 17.9 | 7.9 |
| 20 | 37.3 | 17.3 |
| 25 | 48.4 | 23.4 |
| 30 | 62.3 | 32.5 |

Further embodiments may include an electrodeless lamp, such as shown in FIG. 6, which is positioned in a microwave applicator, cavity, or resonator and energized with suitable high frequency power (preferable within an ISM band such as 0.915 or 2.54 GHz) to produce light. The lamp surface is textured to achieve the same gain as in the electroded case. In this embodiment, the lamp contains no electrodes and may require at most one capillary 50 for filling and positioning of the lamp. The capillary may have a ceramic rod 80 inserted therein to fill the capillary cavity. An HF source and tuner 85 may be connected to HF excitation coils 90 with a cable 95 to provide a discharge inside the envelope.

The facets may also be ground and polished into the outer surface of the lamp envelope in a continuous fashion so that the surface appears wavy, with no sharp edges.

The “flat” surfaces described and claimed herein are as flat as reasonably expected in an expendable commercial item. High precision flatness, such as found on facets of gemstones and in some laser mirrors, is not required. The flat surfaces herein may have some minimal (unintended) curvature that is a remnant of the manufacturing process without detracting from the invention.

While embodiments of the present invention have been described in the foregoing specification and drawings, it is to be understood that the present invention is defined by the following claims when read in light of the specification and drawings.

What is claimed is:

1. A high intensity discharge lamp, comprising a ceramic envelope defining an axis and an enclosed volume, said enclosed volume being filled with a pressurized gas, said envelope having an exterior with an equator transverse to said axis and plural surfaces that are each flat in longitudinal cross section and aligned relative to said axis to refract light emitted from inside said envelope toward a plane of said equator.

2. The lamp of claim 1, wherein said envelope has a spherical interior surface.

3. The lamp of claim 1, wherein said envelope is an arc tube that comprises capillaries that extend axially thereof and respective electrodes in said capillaries that extend inside said arc tube.

4. The lamp of claim 1, wherein said lamp is electrodeless and said envelope comprises a capillary that extends from said envelope.

5. The lamp of claim 1, wherein said plural surfaces are annular relative to said axis.

6. The lamp of claim 5, comprising at least two of said plural annular surfaces on each side of said equator.

7. The lamp of claim 1, wherein each of said plural surfaces is planar, and wherein said planar surfaces are arrayed in concentric tiers that extend around the envelope on both sides of said equator, each of said tiers being at a respective plane that is generally parallel to a plane of said equator.

8. The lamp of claim 1, wherein each of said plural surfaces is angled so as to substantially avoid total internal reflection of the light from a center of said envelope.

9. The lamp of claim 1, wherein said plural surfaces form a saw tooth pattern in longitudinal cross section.

10. The lamp of claim 1, wherein said envelope comprises a polycrystalline sintered ceramic.

11. The lamp of claim 1, wherein said envelope comprises a cubic polycrystalline ceramic.

12. The lamp of claim 11, wherein said ceramic is one of aluminum oxynitride and dysprosium oxide.

13. The lamp of claim 1, wherein said envelope contains mercury, argon, and bromine.

14. The lamp of claim 13, wherein the mercury is in the range of 100-300 mg/cm³, the argon is in the range of 3 to 400 kPa, and the bromine in the range of 2 to 20 μg/cm³.

15. A high intensity discharge lamp, comprising a ceramic envelope defining an enclosed volume, the enclosed volume being filled with a pressurized gas, said envelope having an exterior with axial poles and an equator and, when viewed in longitudinal cross section, plural exterior steps extending in series from respective ones of the axial poles to the equator, each of said steps having a flat exterior surface that is angled to refract light from inside said envelope toward a plane of said equator.

16. The lamp of claim 15, wherein each of said flat surfaces is planar.

17. The lamp of claim 15, wherein said flat surfaces are annular relative to the axial poles of said envelope.

18. The lamp of claim 15, wherein each of said flat surfaces is angled so as to substantially avoid total internal reflection of the light from a center of said envelope.

19. The lamp of claim 15, wherein said envelope has a spherical interior surface.

20. The lamp of claim 15, further comprising a reflector having an aperture that is aligned with a respective one of the axial poles.
